(19) United States
(12) Patent Application Publication
(10) Pub. No.: US 2019/0280961 A1
(43) Pub. Date: Sep. 12, 2019

(54) COMMUNICATION NODES, DISTRIBUTED COMMUNICATION NETWORK ARCHITECTURES, AND METHODS FOR COMMUNICATION IN A DISTRIBUTED COMMUNICATION NETWORK IN A VEHICLE

(71) Applicant: Gulfstream Aerospace Corporation, Savannah, GA (US)

(72) Inventors: Scott Bohanan, Savannah, GA (US); Fred Taylor, Savannah, GA (US); Jim Jordan, Savannah, GA (US); Matthew Winslow, Savannah, GA (US)

(21) Appl. No.: 15/919,109

(22) Filed: Mar. 12, 2018

(51) Int. Cl. H04L 12/735; H04L 12/703; H04L 12/725; H04L 12/707

(52) U.S. Cl. CPC H04L 45/128; H04L 45/28; H04L 63/0435; H04L 45/24; H04L 45/306

(57) ABSTRACT

A communication node, such as a line replaceable unit and/or a sensor for use in a distributed communication network in a vehicle, particularly an aircraft, is provided. The communication node includes, but is not limited to a communication module and a processor unit. The communication module is configured to communicate with a target communication module of a target communication node of a plurality of communication nodes in the distributed communication network in the vehicle. The processor unit is configured to automatically and dynamically determine an optimum communication path through the communication network for communication between the particular communication node and a target communication node and to configure the communication module to exchange data with the target communication node over the optimum communication path through the distributed communication network.

### TECHNICAL FIELD

Embodiments of the present invention generally relate to communication networks, and more particularly to distributed communication network architectures for vehicles.

### BACKGROUND OF THE INVENTION

Aircraft implementation of so called line replaceable units (LRUs) and sensor integration is often based on redundant wiring paths. Often, communication data busses are physical copper wires in the aircraft today. This can create duplicate harness and connector weight throughout the aircraft.

In addition, current LRUs rely on a centralized node or master computer to send and receive data from the aircraft to various sensors and subsystems.

It is desirable to further reduce the cost and weight of aircraft as well as the manufacturing and maintenance complexity. Furthermore, other desirable features and characteristics of the present invention will become apparent from the subsequent detailed description and the appended claims, taken in conjunction with the accompanying drawings and the foregoing technical field and background.

### SUMMARY

The disclosed embodiments relate to a communication node for use in a distributed communication network in a vehicle is provided. The communication node includes, but is not limited to communication module and a processor unit. The communication module is configured to communicate with a target communication module of a target communication node of a plurality of communication nodes in the distributed communication network in the vehicle. The processor unit is configured to automatically and dynamically determine an optimum communication path through the communication network for communication between the particular communication node and a target communication node and to configure the communication module to exchange data with the target communication node over the optimum communication path through the distributed communication network.

In accordance with the disclosed embodiments, the communication module can be a wireless communication module, such as a WIFI-module, a GSM-module, an LTE-module or any other suitable wireless communication module. Of course, the wireless communication module can also be a wired communication module, such as an ethernet cable module, for example.

A communication node of the distributed communication network can be a so-called line replaceable unit (“LRU”) or a sensor, such as a pressure sensor, for example.

In the context of the present disclosure, a target communication node is a communication node in a distributed communication network that is to be contacted by a source communication node that submits data or information to the target communication node. The target communication node may be a repeater that repeats the data or information to a destination. Alternatively, the target communication node may be the destination of the data or information.

According to an aspect, disclosed embodiments relate to a distributed communication network for a vehicle. The distributed communication network includes, but is not limited to a plurality of communication nodes. Further, each communication node of the plurality of communication nodes includes, but is not limited to a communication module and a processor unit. The communication module is configured to communicate with a target communication module of a target communication node of the plurality of communication nodes. The processor unit is configured with an algorithm to automatically and dynamically determine an optimum communication path through the distributed communication network for communication between a communication node associated with the processor and the target communication node and to configure the communication module to exchange data with the target communication module over the optimum communication path through the distributed communication network.

According to a further aspect, disclosed embodiments relate to a method for communication in a distributed communication network for use in a vehicle comprising a plurality of communication nodes. The method includes, but is not limited to determining, by a processor unit of a communication node of the plurality of communication nodes, data that are to be transmitted from the communication node to a target communication node in the distributed communication network based on data requests received from another communication node of the plurality of communication nodes. The method further includes, but is not limited to calculating an optimum communication path between the communication node and a target communication node based on information about at least one of traffic in the distributed communication network and latency between communication nodes of the plurality of communication nodes and transmitting the data via the optimum communication path using a communication module of the communication node.

An optimum communication path is a communication path with a lowest jitter and/or a lowest latency and/or minimal data packet collisions. The optimum communication path may be deterministic in a normal or standard setting. Alternatively, algorithms such as Dijkstra's algorithm, Bellman-Ford algorithm, A* search algorithm, Floyd-Warshall algorithm, Johnson's algorithm, and Viterbi algorithm or other shortest path algorithms may be used to determine the optimum communication path, in case a deterministic communication path is not available or not valid due to technical reasons, for example.

### DESCRIPTION OF THE DRAWINGS

Embodiments of the present invention will hereinafter be described in conjunction with the following drawing figures, wherein like numerals denote like elements, and

FIG. 1 is a schematic view illustrating a distributed communication network in accordance with one non-limiting implementation of the disclosed embodiments;

FIG. 2 is a schematic view illustrating an aircraft including a non-limiting embodiment of a distributed communication network in accordance with the disclosed embodiments;

FIG. 3 is a schematic view illustrating a communication node in accordance with one non-limiting implementation of the disclosed embodiments;

FIG. 4 is a flow chart illustrating an exemplary method for communication in a distributed communication network in a vehicle in accordance with one non-limiting implementation of the disclosed embodiments; and

FIG. 5 is a flow chart illustrating an exemplary method for communication in a distributed communication network in accordance with one non-limiting implementation of the disclosed embodiments.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary or the following description.

It is desirable to provide a communication network architecture in an aircraft that is easy to extend or to reduce. It would also be desirable to improve the integration of various aircraft systems.

In conventional aircraft, communication devices or communication nodes rely on a centralized node or master computer to send and receive data from the aircraft to various sensors and subsystems.

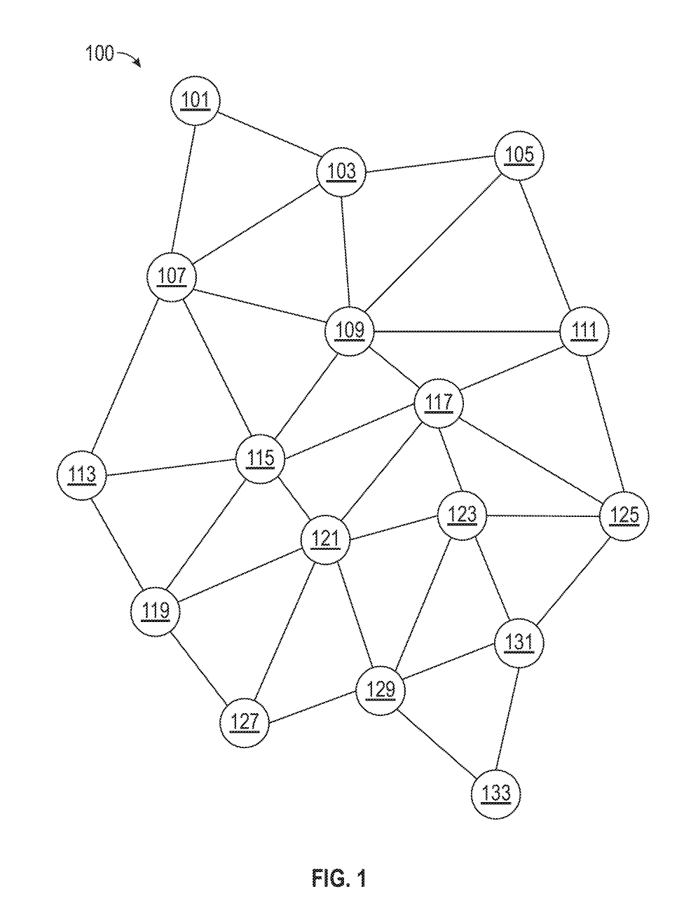

The disclosed embodiments relate to distributed communication network architectures. The distributed communication network can be installed in vehicles. In one exemplary implementation, that will be described below with reference to FIGS. 1-4, the vehicle is an aircraft. However, it should be appreciated that the disclosed embodiments can be implemented within any other type of vehicle including, but not limited to, land (e.g., automobiles), water (e.g., boats, ships, submarines), air (e.g., helicopters, drones, etc.) or space vehicles. In addition, in some implementations, the disclosed embodiments can be implemented in other installations such as ground facilities (e.g., industrial facilities, power plants, etc.). Communication nodes are arranged throughout the aircraft. Each communication node is part of the distributed communication network and can serve as a repeater for data or information to be distributed over the distributed communication network. Each communication node comprises at least one processor unit that is configured to determine an optimum communication path through the distributed communication network for particular data or information to be submitted to a target communication node. The target communication node may be a repeater that repeats the data or information to a destination. Alternatively, the target communication node may be a consumer of the data or information. Thus, the path may comprise a plurality of repeaters, a plurality of repeaters and a destination, a single repeater and a destination, or only one destination.

Each communication node of the distributed communication network may serve as a repeater and relay data submitted from a source communication node to a target communication node or another repeater.

A greater understanding of the systems, devices, and methods described above may be obtained through a review of the illustrations accompanying this application together with a review of the detailed description that follows.

FIG. 1 shows a distributed communication network 100 in accordance with one exemplary, non-limiting implementation. FIG. 1 illustrates a distributed communication network that comprises various communication nodes 101, 103, 105, 107, 109, 111, 113, 115, 117, 119, 121, 123, 125, 127, 129, 131 and 133. Each of the communication nodes 101 to 133 comprises at least one processor unit (not shown) and at least one communication module (not shown). The communication module of each communication node 101 to 133 is configured to communicate with other communication modules of the plurality of communication nodes 101 to 133 in the distributed communication network 100. The processor unit of each communication node 101 to 133 is configured to automatically and dynamically determine an optimum communication path through the communication network 100 for communication between a particular communication node 101 to 133 and a target communication node 101 to 133 and to configure the communication module of the particular communication node 101 to 133 to exchange data with a target communication node 101 to 133 over the optimum communication path through the distributed communication network 100. The optimum communication path between a source communication node 101 to 133 and a target communication node 101 to 133 may include a varying amount of other communication nodes 101 to 133.

In an example, the communication node 101, which may be a line replaceable unit (“LRU”), may be used to transmit data to the communication node 111, which may be a sensor, for example. Thus, a processor unit of the communication node 101 determines an optimum communication path to the communication node 111. For this purpose, the processor unit of the communication node 101 may use information about a latency of a connection between the communication nodes 103, 105, 111 and compare this latency with a latency of a connection between the communication nodes 103, 109, 111 and choose the one with a smaller latency.

Since the processor units of the communication nodes 101 to 133 are configured to determine an optimum communication path automatically and dynamically using algorithms that are based on latency and/or traffic load and/or a distance between particular communication nodes, the distributed communication network 100 may change over time without any need for reconfiguration of the processor units or the communication modules of the communication nodes 101 to 133 of the distributed communication network 100. The algorithm may be based on a connectivity strength of each communication line in the distributed communication network, wherein a connectivity strength is defined by at least one of a jitter, a latency and reliability of a bandwidth thru-put. This means, the distributed communication network 100 is resistant to drops or failures of particular communication nodes and may adapt easily to added communication nodes. Thus, the number of communication nodes in the distributed communication network may vary without any need for reconfiguration of the remaining communication nodes.

The distributed communication network 100 may be a distributed ad-hoc wireless computing network of Line Replaceable Units (LRUs) and Sensors. The distributed communication network 100 reduces a required wire and connector weight and eliminates the need for a central node that all of the data has to pass through, like a Modular Avionics Unit (MAU) or Data Concentration Network (DCN) switch.

The distributed communication network 100 may use end-to-end encryption and hardware cryptography for security. Thus, each communication node 101 to 133 may use an encryption and/or decryption key for communication in the distributed communication network 100.

The distributed communication network 100 does not require access points or data concentration components. Data is shared between communication nodes 101 to 133, such as LRUs and Sensors dynamically, based on the current data needs and requests, for example. Additional communication nodes can be added to the distributed communication network 100 without re-configuring the existing infrastructure and new communication paths can automatically be created. The health of the network can be monitored and reported by various communication nodes 101 to 133, thus providing no single point of failure. The term communication node and the term LRU can particularly refer to subsystem components such as touch screen controllers or standby displays.

Each communication node 101 to 133, particularly each LRU can contain common algorithms and processing capabilities used to determine the data it needs to consume and source on the distributed communication network 100. Each communication node 101 to 133, particularly each LRU acts as a repeater of data, such that latency issues are minimized. If a communication between communication nodes fails during operation, the distributed communication network 100 can re-configure itself and find an alternate communication path to continue to provide the required data. Since wireless communication can be used between the communication nodes 101 to 133, minimum wiring is required in the aircraft. Physical wiring would consist of power and a backup data bus in case the wireless network was inoperable.

The frequency of the distributed communication network 100 can be high enough in the GHz band that a required RF power will not penetrate beyond the aircraft skin. Also, the distributed communication network 100 may be immune to jamming or interference at this higher frequency. Typical ARINC 600 type connectors which drive the overall size of a communication node can be eliminated and will shrink an envelope size of communication nodes 101 to 133 used in the distributed communication network 100. These smaller LRU's can be combined, thus reducing their physical size, and relocated to other areas of the airplane that could potentially gain more usable cabin volume and decrease total aircraft weight. It should be appreciated that the distributed communication network 100 may comprise more or fewer communication nodes as the communication nodes 101 to 133.

In an example, at least one communication node 101 to 133 of the distributed communication network 100 may be configured to communicate with a communication device that is not a communication node, such as a receiver, for example.

In another example, the distributed communication network 100 may comprise a plurality of communications nodes 101 to 133 and at least one communication device that is not a communication node. The communication device may be configured to communicate with at least one communication node of the distributed communication network 100 in order to determine an optimum communication path to the communication device.

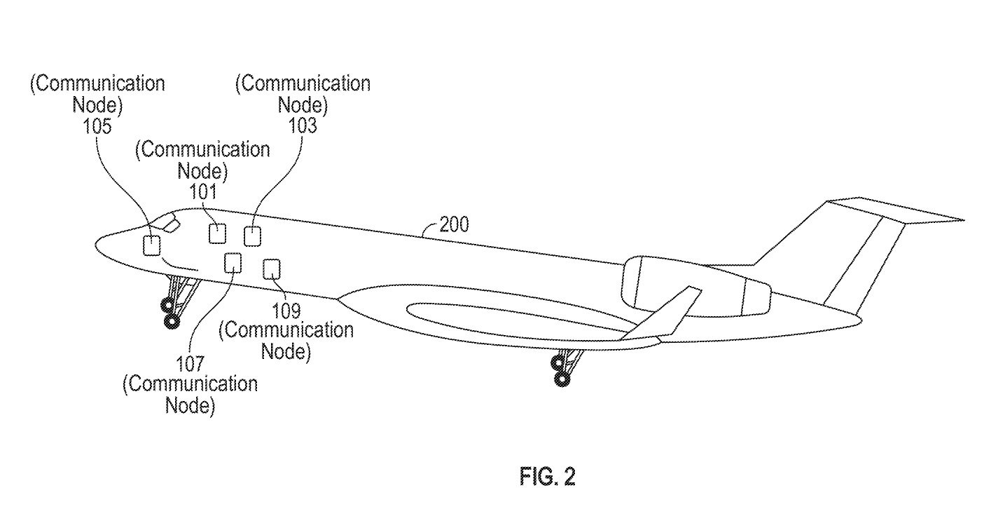

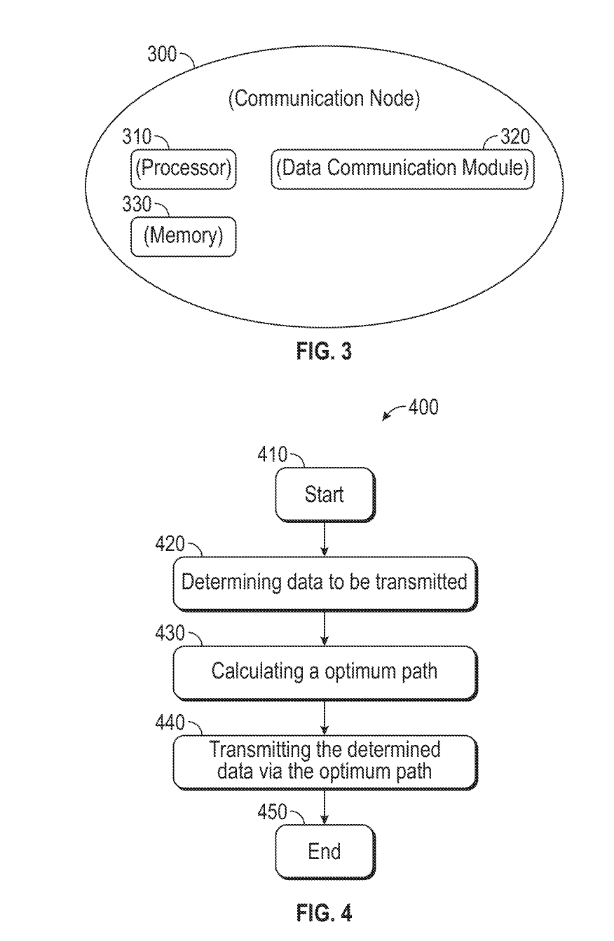

FIGS. 1 and 2 are intended to illustrate a conceptual representation of the distributed communication network 100 in a vehicle, according an embodiment. It should be appreciated that the communication nodes 101 to 133 can be located anywhere onboard the vehicle, which is here an aircraft, for example. Moreover, the number and relative locations of the communication nodes are non-limiting. In other words, any number of communication nodes 101 to 133 can be included within the aircraft 200 and the nodes can be mounted anywhere throughout the aircraft 200. As will be described below with reference to FIGS. 2-3, the communication nodes 101 are part of a distributed aircraft communication platform that can be used to implement a scalable integrated communication network architecture within the aircraft 200. Although not shown in FIG. 2, the aircraft 200 may also include various other onboard computers, aircraft instrumentation, and additional control systems that are not illustrated for sake of clarity.

According to an embodiment, the distributed communication network 100 is controlled and monitored by every communication node 101 to 133 in the network separately. This means that a communication within the distributed communication network is controlled and monitored in many redundant ways by each communication node 101 to 133.

According to another embodiment, the processor unit of every communication node 101 to 133 in the distributed communication network 100 is configured to be switched into a learning mode and to change communication parameters used for communication in the distributed communication network 100, if a new device is found that meets the criteria for enrolling in the distributed communication network and that is included in the distributed communication network. In other words, the communication nodes 101 to 133 will recognize a new communication node and included the new communication node into their calculations for the optimum communication path automatically and dynamically.

According to another embodiment, the processor unit of each communication node 101 to 133 is configured to check if the new device meets the criteria for enrolling in the distributed communication network by using at least one encryption key to decrypt a message from the new device and, if the message is decrypted successfully, to enroll the new device in the distributed communication network as a new communication node.

According to another embodiment, the processor unit of each node 101 to 133 is configured to monitor a state of the distributed communication network 100 and, if a communication node 101 to 133 becomes inactive, to exclude the inactive node 101 to 133 from using it as a repeater of data and to determine a new path for communicating data through the distributed communication network 100 that is only based on active communication nodes 101 to 133, which means that inactive communication nodes are excluded from communication over the optimum communication path. A communication node may be recognized as inactive by another communication node, if the communication node shows a latency that is above a given threshold or if the communication node submits a message telling that it is inactive for a given time window, for example.

In FIG. 2, communication nodes 101 to 109 are parts of a communication network of the airplane 200, such as data consumers and/or data receivers, for example. The communication nodes 101 to 109 are linked and organized as described above with respect to FIG. 1.

Other features of nodes and the aircraft 200 will now be described below with reference to FIGS. 3 through 4.

FIG. 3 shows an example of a communication node 300 in accordance with the disclosed embodiments.

The communication node 300 is an LRU or sensor unit. In one embodiment, the communication node 300 includes a processor unit 310 that performs a variety of processing and control functions; and a data communication module 320. In another embodiment, the processor unit 310 and the communication module 320 can be one or more electronic components installed on one or more circuit boards. The communication node 300 also includes a memory 330 that stores an algorithm that configures the processor unit 310 to determine an optimum communication path for transmitting data or information through the distributed communication network 100, when the algorithm is executed by the processor unit 310. Further, the memory 330 can store software components that are not illustrated for sake of clarity.

The processor unit 310 is configured to automatically and dynamically determine an optimum communication path through the communication network for communication between the communication node 300 and a target communication node and to configure the communication module to exchange data with the target communication node over the determined optimum communication path through the distributed communication network.

The processor unit 310 performs the computation and control functions of the communication node 300. As used herein, a “processor” or “processor unit” can refer to any type of conventional processor, controller, microcontroller, field programmable gate array (FPGA), digital signal processor (DSP) or state machine. A processor unit can be implemented using a single processor or multiple processors that are not part of a single unit. Further, a processor unit may comprise single integrated circuits such as a microprocessor, or any suitable number of multiple processors or integrated circuit devices and/or circuit boards working in cooperation to accomplish the functions of a processor. Thus, a processor unit is not necessarily implemented as a single discrete unit in all embodiments, but may also be implemented using a plurality of said processors that are distributed throughout the node. It should be understood that the memory 330 may be a single type of memory component, or it may be composed of many different types of memory components. The memory 330 can include non-volatile memory (such as ROM, flash memory, etc.), memory (such as RAM), or some combination of the two. The RAM can be any type of suitable random access memory including the various types of dynamic random access memory (DRAM) such as SDRAM, the various types of static RAM (SRAM). The RAM may include an operating system, and executable code for power control programs and data conversion programs that can be loaded and executed at the processor to convert or translate data received by the processor unit 310. The data conversion programs can include configuration files that describe a data source of particular data, a data consumer for that particular data, and instructions for how that particular data needs to be processed and re-formatted prior to sending it over the bus toward the intended data consumer.

The processor unit 310 is configured to control the communication module 320 to submit and/or receive data and/or information to and/or from the distributed communication network 100, i.e. from particular communication nodes 101 to 133 of the distributed communication network 100. The processor unit 310 generates control signals (or “commands”) that are communicated to the communication module 320 to control communication with other communication nodes 103 to 133 throughout the aircraft 200 (as will be described in greater detail below with reference to FIG. 4). In another embodiment, the processor unit 310 can receive control signals that are generated by vehicle systems and subsystems that are external to the communication node 300 such as Flight Control Computers, Flight Management Systems, or control inputs activated by the driver or pilot that are external to the node, and are part or not part of the distributed communication network 100.

For example, in one embodiment, if two or more communication nodes wish to communicate with the communication node 300, the processor unit 310 of the communication node 300 is configured to buffer the received data in the memory 330 or an internal memory of the processor unit 310 and use a prioritization method to determine which data received from the two or more communication nodes to process first. Thus, the processor unit 310 may be configured to build a priority line for communication of important information.

The processor unit 310 can be implemented via a microprocessor-based controller. The processor unit 310 can convert input data from one form to another before outputting it. In one embodiment, the processor unit 310 can receive input data (in discrete, analog or digital form) from a variety of different transmitting systems via the communication module 320. The processor unit 310 can process and reformat the input data into a common digital data format so that it can be communicated via communication module 320 over a high-bandwidth digital network. For example, in one implementation, the processor unit 310 functions as a protocol converter that can convert incoming input signals per a network protocol such as EIA/TIA-232, EIA/TIA-422, EIA/TIA-485, ARINC 429, USB, ARINC-664, MIL-STD-1553, CAN bus and Ethernet, etc. In addition, the processor 310 can receive data that has been converted per the network protocol, and convert the converted data back into a form that is useable by the various consumers.

The communication module 320 allows the communication node 300 to be connected to other communication nodes, network switches, Integrated Modular Avionics (IMA) units that include additional control units, databases, or other electronic equipment onboard the aircraft. The communication node 300 can be designed for communication in accordance with a high-bandwidth bus protocol such as Ethernet, A664, AFDX, etc.

FIG. 4 is a diagram that illustrates different aspects of a method for communication in a distributed communication network according to an embodiment. In FIG. 4, a method 400 for communication in a distributed communication network for use in a vehicle according to an embodiment is described. The method starts at step 410. In a determination step 420, data that are to be transmitted from the communication node to a target communication node in the distributed communication network are determined by a processor unit of the communication node based on data requests received from a providing or source communication node and/or a target communication node.

In a calculation step 430, an optimum communication path between the communication node and the target communication node is calculated by a processor unit of the communication node, based on information about at least one of current traffic in the distributed communication network, latency between particular communication nodes in the distributed communication network.

In a transmission step 440, the data determined in determination step 420 are transmitted via the optimum communication path calculated in calculating step 430 using a communication module of communication node.

In an example, the data determined in determination step 420 may be data that are to be transmitted from the communication node to the target communication node. Alternatively, the data determined in determination step 420 may be data that are to be repeated and, therefore, are transmitted from a source communication node to the communication node and from the communication node to the target communication node or a further communication node. The method terminates at 450.

As described above, a plurality of communication nodes can be distributed throughout a distributed communication network in an aircraft. Thus, in some implementations, the disclosed embodiments allow for replacement of most or all system controllers, central computers, data concentration devices and networks that are necessary for controlling communication in a vehicle. As a result, system capabilities and resources can be more efficiently utilized, and significant reductions in weight and installation and maintenance complexity can be achieved.

In addition, the distributed aircraft systems platform improves systems integration by combining a distributed communication network.

The distributed communication network also allows higher robustness to localized damage, due to the increased ability to perform functions in alternative ways. This is due to the fact that the distributed communication network contains a plurality of communication nodes that are organized automatically and dynamically for the optimum and thus, the fastest possible communication.

Because wiring and other hardware components can be removed with this distributed communication network architecture, particularly on larger aircraft, can significantly reduce system weight while improving safety. The distributed communication network architecture can also reduce manufacturing and maintenance costs.

Those of skill in the art would further appreciate that the various illustrative logical blocks, modules, circuits, described in connection with the embodiments disclosed herein may be implemented as electronic hardware, computer software, or combinations of both. Some of the embodiments and implementations are described above in terms of functional and/or logical block components (or modules). However, it should be appreciated that such block components (or modules) may be realized by any number of hardware, software, and/or firmware components configured to perform the specified functions. To clearly illustrate this interchangeability of hardware and software, various illustrative components, blocks, modules, circuits, have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied directly in hardware, in a software module executed by a processor, or in a combination of the two. A software module may reside in RAM memory, flash memory, USB flash memory stick, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. For example, although the disclosed embodiments are described with reference to a flight control computer of an aircraft, those skilled in the art will appreciate that the disclosed embodiments could be implemented in other types of computers that are used in other types of vehicles including, but not limited to, spacecraft, submarines, surface ships, automobiles, trains, motorcycles, etc. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

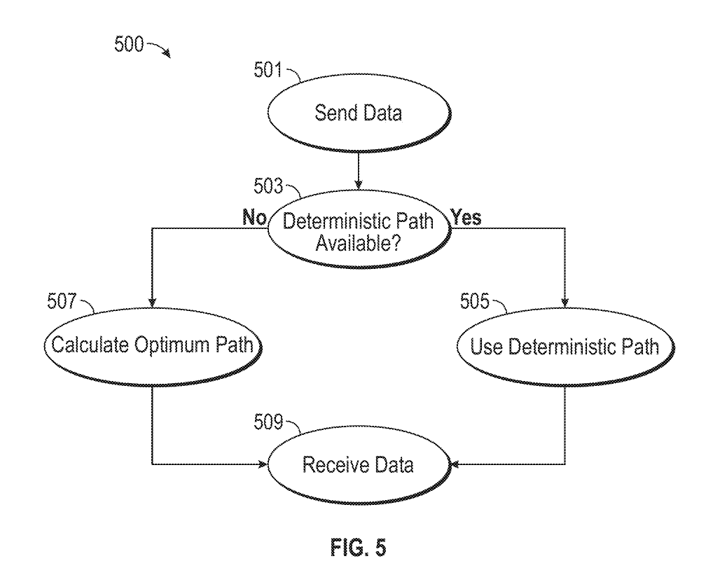

In FIG. 5, a flow chart 500 of an exemplary method for communication in a distributed communication network is shown. In order to send data from a sender communication node to a target communication node of a communication network in a sending step 501, a processor unit of the sender communication node checks in a review step 503 for availability of a deterministic communication path on a server, for example. If a deterministic communication path is available, the deterministic communication path is used in a transmission step 505 to send the data to the target communication node, which receives the data via the respective bus in receiving step 509.

If no deterministic communication path is available, an optimum communication path is calculated using a shortest path algorithm such as Dijkstra's algorithm, Bellman-Ford algorithm, A* search algorithm, Floyd-Warshall algorithm, Johnson's algorithm, or Viterbi algorithm in a calculation step 507 using a processor unit of the sender node or a processor unit of a server, for example. The sender node transmits the data via the calculated optimum communication path to the target communication node, which receives the data in receiving step 509.

The optimum communication path calculated in calculation step 507 may be stored in a memory, such as a memory of a server, for example, and may be used as a determined communication path for data to be sent in the future.

1-18. (canceled)

19. A vehicle communication network, comprising:
a source communication node that is the source of data;
a plurality of repeater communication nodes; and
a destination communication node including a processor configured to:
determine that the destination communication node consumes the data;
identify the source communication node as the source of the data;
determine an optimum communication path from the source communication node to the destination communication node through the plurality of repeater communication nodes; and
retrieve the data from the source communication node along the optimum path.

20. The vehicle communication network of claim 19,
wherein the destination communication node is a line replaceable unit (LRU) and the source communication node is a sensor.

21. The vehicle communication network of claim 19,
wherein the source communication node, the plurality of repeater communication nodes, and the destination communication node are configured to communicate using wired communication modules.

22. The vehicle communication network of claim 19,
wherein the source communication node, the plurality of repeater communication nodes, and the destination communication node are configured to communicate using wireless communication modules.

23. The vehicle communication network of claim 19,
wherein the source communication node, the plurality of repeater communication nodes, and the destination communication node are configured to communicate using wired communication modules.

24. The vehicle communication network of claim 19,
wherein the processor of the destination communication node is configured to determine the optimum communication path based on traffic in the vehicle communication network and on a latency between the source communication node and the destination communication node.

25. The vehicle communication network of claim 24, wherein the processor of the destination communication node is further configured to determine the optimum communication path based on a connectivity strength of each of the plurality of repeater communication nodes.

26. The vehicle communication network of claim 19, wherein the processor of the destination communication node is configured to buffer received data and use a prioritization method to determine which of the received data to process first when two or more of the plurality of repeater nodes wish to communicate with the destination communication node.

27. The vehicle communication network of claim 19, wherein the vehicle communication network is controlled and monitored by every communication node in the network separately.

28. The vehicle communication network of claim 19, wherein the processor unit of every communication node in the distributed communication network is configured to be switched into a learning mode that enables the respective communication node to change communication parameters used for communication in the vehicle communication network when a new device that meets criteria for enrolling in the vehicle communication network is enrolled in the vehicle communication network.

29. The vehicle communication network of claim 26,
wherein, in the learning mode, each communication node is configured to check if the new device meets the criteria for enrolling in the distributed communication network by using an encryption key to decrypt a message from the new device and to enroll the new device in the distributed communication network as a new communication node when the message is decrypted.

30. The vehicle communication network of claim 19, wherein each communication node is configured to monitor a current state of the vehicle communication network and, when another communication node of the vehicle communication network becomes an inactive communication node, to exclude the inactive communication node from use of the inactive communication node as a repeater of data and to determine a new path for communicating data through the distributed communication network that excludes the inactive communication node.

31. The vehicle communication network of claim 19, wherein data that are communicated between the source communication node and the destination communication node are encrypted using one of an end-to-end encryption algorithm and a hardware cryptography.

32. The vehicle communication network of claim 19, wherein each of the plurality of repeater communication nodes is one of a line replaceable unit and a sensor.

33. The vehicle communication network of claim 19, wherein every communication node is configured to work as a repeater of transmissions that are transmitted in the vehicle communication network.

34. A vehicle, comprising:
a vehicle communication network comprising:
a source communication node that is the source of data;
a plurality of repeater communication nodes; and
a destination communication node including a processor configured to:
determine that the destination communication node consumes the data;
identify the source communication node as the source of the data;
determine an optimum communication path from the source communication node to the destination communication node through the plurality of repeater communication nodes; and
retrieve the data from the source communication node along the optimum path.
